(19) United States
(12) Patent Application Publication
(10) Pub. No.: US 2020/0104892 A1
(43) Pub. Date: Apr. 2, 2020

(54) Group reverse auction shopping method and implementation on a computer network

(71) Applicant: VEDAT ARAL, Irvine, CA (US)

(72) Inventor: VEDAT ARAL, Irvine, CA (US)

(21) Appl. No.: 16/147,713

(22) Filed: Sep. 29, 2018

(51) Int. Cl. G06Q 30/06

(52) U.S. Cl. CPC G06Q 30/0605; G06Q 30/0641; G06Q 30/0609; G06Q 30/0611

(57) ABSTRACT

A group reverse auction shopping method and a system to combine orders of particular products with same brand, model, color, shipping date and auction closing date from multiple buyers into a single group order then allowing accredited sellers to sell to the group collectively based on their price, offer time and stock availability.

### BACKGROUND OF THE INVENTION

### Field of the Invention

The present invention relates to a reverse auction shopping method, particularly to the method combining orders of a particular product from multiple buyers into a single group order then allowing accredited sellers to sell to the said group order collectively based on their price, offer time and quantity. The present invention further relates to implementation of the said method as a computer application on a computer network connected over the internet.

### Description of the Related Art

Conventional methods and applications are known in the art providing reverse auction method over a computer network. A typical reverse auction application allows a buyer to request an offer for a product or service and accredited sellers to race against each other to win the business. The determination of the winning offer varies per method. Some methods let only the lowest price to win, some let buyer to select among the sellers by variety of dimensions other than price, such as service quality; and some allow a last negotiation phase among the sellers.

Conventional methods use a single buyer, and winner takes all approach, which can be disadvantageous to buyers and sellers in certain cases. Buyers may not get the possible discounted price when they need to buy just a single item or in low quantities. Also, sellers may stay out of auction process or offer higher prices if the quantity is low. In case of multiple quantity purchases, some sellers may not have enough stock on hand, forced to stay out of the auction process even when they could offer better prices.

Conventional methods can be improved by allowing buyers to group their orders to take advantage of buying in bulk quantities; and giving sellers a chance to sell even when they didn't have the best price or didn't have enough quantity on hand.

### SUMMARY OF THE INVENTION

The object of the present invention is to combine purchase orders of the exact same product from multiple buyers into a single group order to get benefit of buying in bulk quantities.

A further object of the present invention is to allow buyers to purchase the same product from multiple sellers when a seller didn't have enough stock on hand.

A further object of the present invention is to help sellers to sell in bulk quantities of the same product to one or multiple buyers in a single sale.

A further object of the present invention is to allow multiple sellers to sell the same product collectively in a single sale based on their price, offer date and time, and quantity on hand.

A further object of the present invention is to award buyers with best prices when they committed to the purchase by paying a deposit.

A further object of the present invention is to award buyers with best prices by their order entry date and time.

A further object of the present invention is to allow sellers to offer same price.

A further object of the present invention is to award sellers by their offer price.

A further object of the present invention is to award sellers by their offer date and time in case of same prices were offered.

To achieve the above and other objects, the present invention introduces a new reverse auction method and an online computer application that collects orders of a particular product with same brand, model, color, shipping method and auction closing date from multiple buyers to form group orders and lets accredited sellers to submit their offers on grouped orders.

According to present invention, the application lets sellers to submit offer price and offer quantity, on the combined order. Sellers can offer one or multiple quantity based on their stock availability.

According to present invention, the application allows buyers and sellers to change their prices and quantities until the auction closing date.

According to present invention, the application sorts then awards buyers with best offers in following order: the buyers with deposit payment are placed above the buyers without deposit payment, then the buyers sorted by their order entry date and time in ascending order among the buyers who paid the deposit and lastly the buyers sorted by their order entry date and time in ascending order among the buyers who haven't paid the deposit.

According to present invention, all buyers in the combined order are awarded as long as there is enough offer to match their quantity and desired purchase price.

According to present invention, the application sorts then awards sellers by their offer price in ascending order; and the offer date and time in ascending order, if the offer prices were the same.

According to present invention, all sellers are awarded as long as there are enough buyers and offer prices are equal or lower than buyers' desired purchase price.

### BRIEF DESCRIPTION OF THE DRAWINGS

FIG. 1 is a flowchart depicting step by step ordering process;

FIG. 2 is a flowchart depicting step by step offering process;

FIG. 3 is a flowchart depicting internal process of matching orders with offers and finalizing the purchase; and

FIG. 4 is a flowchart depicting the algorithm to match buyer orders with seller offers.

### DETAILED DESCRIPTION OF THE INVENTION

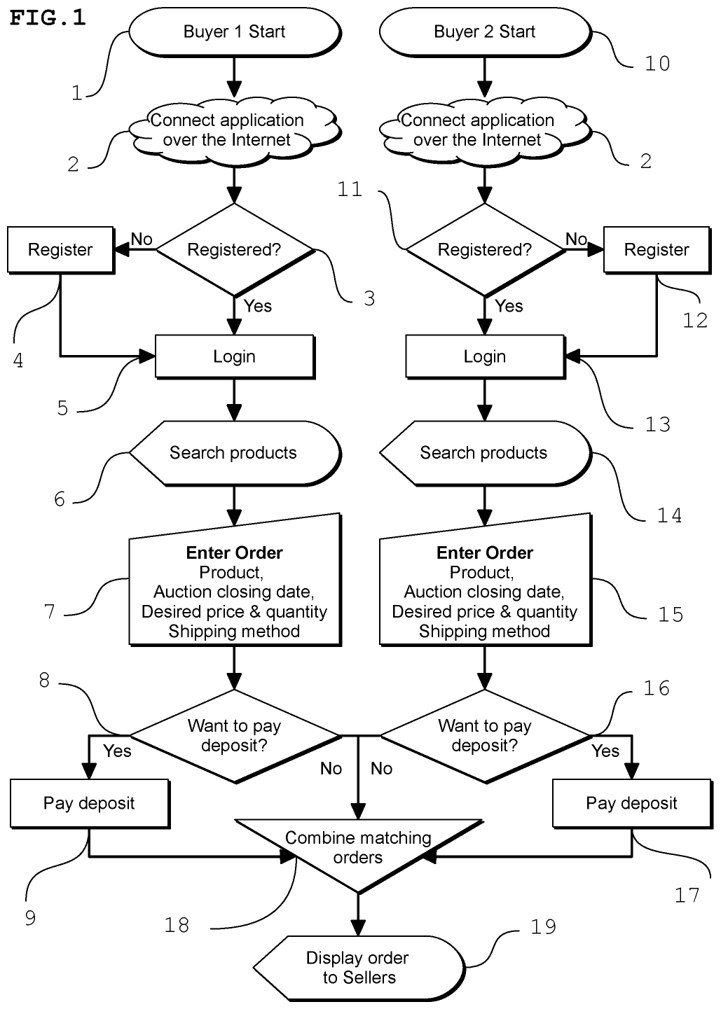

In accordance with the principles of the present invention, referring to FIG. 1, there is depicted the flowchart showing step by step ordering process. The first buyer 1 is connected to online computer application 2 over the internet to place order(s). The buyer 1 must register 4 to use the application 2 means entering an email address, user name, password, billing and shipping address. If the buyer 1 is already registered 3, he/she is taken to login page 5, otherwise the buyer 1 is directed to registration page 4. After registration 4, the buyer 1 is taken to login page 5. After logging in, the buyer 1 searches 6 the product he/she wanted to purchase, then enters the order 7. Along with the product, the buyer 1 enters 7 auction closing date, desired purchase price, quantity and the shipping method. If the buyer 1 wanted to pay a deposit 8, he/she is taken to deposit payment page 9.

Another buyer 10 is connected to online computer application 2 over the internet to place order(s). The buyer 10 must register 12 to use the application 2. If the second buyer 10 is already registered 11, he/she is taken to login page 13, otherwise the buyer 10 is directed to registration page 12. After registration 12, the buyer 10 is taken to login page 13. After logging in, the buyer 10 searches 14 the product he/she wanted to purchase, then enters the order 15. Along with the product, the buyer 10 enters 15 auction closing date, desired purchase price, quantity and the shipping method. If the buyer 10 wanted to pay a deposit 16, he/she is taken to deposit payment page 17.

According the principles of the present invention, there can be indefinite number of buyers using the application 2 to purchase same or different products at the same time. To explain the ordering process, only two users' process depicted and it is assumed that the first buyer 1 and the second buyer 10 are purchasing the same product.

Referring to FIG. 1, the online computer application 2, combines 18 the matching orders from the buyers. Matching orders means the exact same product, shipping method and auction closing date. The combined orders 18 are displayed 19 for sellers to submit their offers.

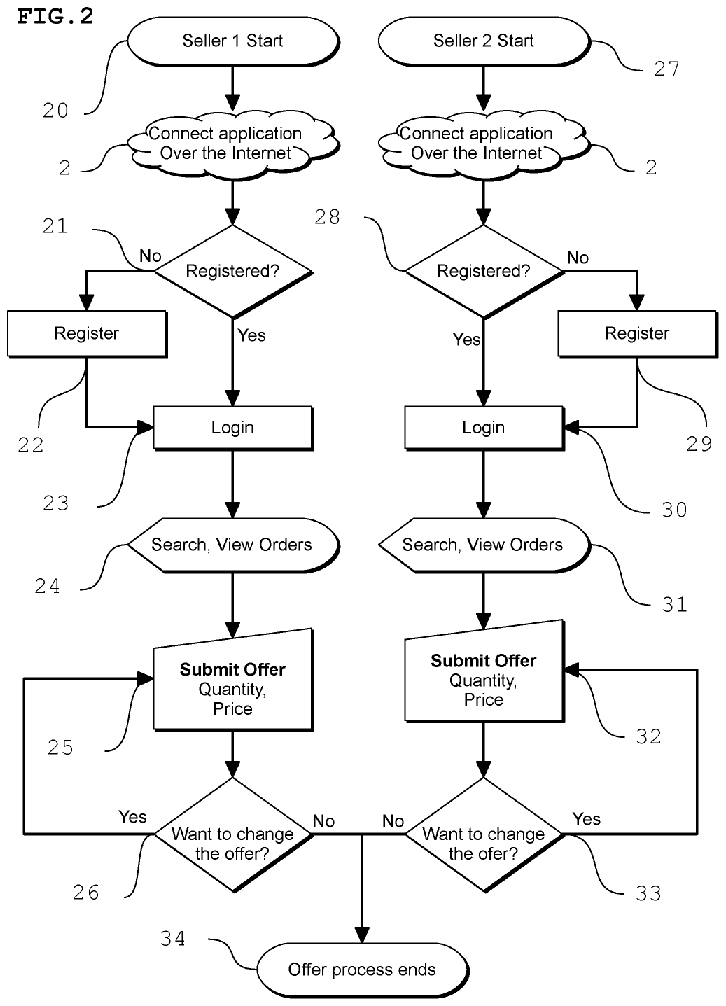

Referring to FIG. 2, there is depicted the flowchart showing step by step offering process. The first seller 20 connected to online computer application 2 over the internet to submit an offer price and quantity. The seller 20 must register 22 to use the application 2 means entering an email address, user name, password and company contact information. If the seller 20 is already registered 21, he/she is taken to login page 23, otherwise the seller 20 is directed to registration page 22. After registration 22, the seller 20 is taken to login page 23. After logging in, the seller 20 searches and views existing orders 24 to find products to submit an offer. If the seller 20 finds an order, submits 25 offer price and quantity on hand. If the seller 20 wanted to change the offer 26 in case the price is higher than other sellers' price or wanted to increase the quantity, submits 25 new price and quantity as many times as needed.

Another seller 27 is connected to online computer application 2 over the internet to submit an offer. The seller 27 must register 29 to use the application 2. If the seller 27 is already registered 28, he/she is taken to login page 30, otherwise the seller 27 is directed to registration page 29. After registration 29, the seller 27 is taken to login page 30. After logging in, the seller 27 searches and views existing orders 31 to find products to submit an offer. If the seller 27 finds an order, submits 32 offer price and quantity on hand. If the seller 27 wanted to change the offer 33 in case the price is higher than other sellers' price or wanted to increase the quantity, submits 32 new price and quantity as many times as needed.

According the principles of the present invention, there can be indefinite number of sellers using the application 2 to sell same or different products at the same time. To explain the offering process, only two sellers' process depicted and it is assumed that the first seller 20 and the second seller 27 are selling the same product.

Referring to FIG. 2, the offer process ends 34 at the auction closing date after collecting all orders and offers.

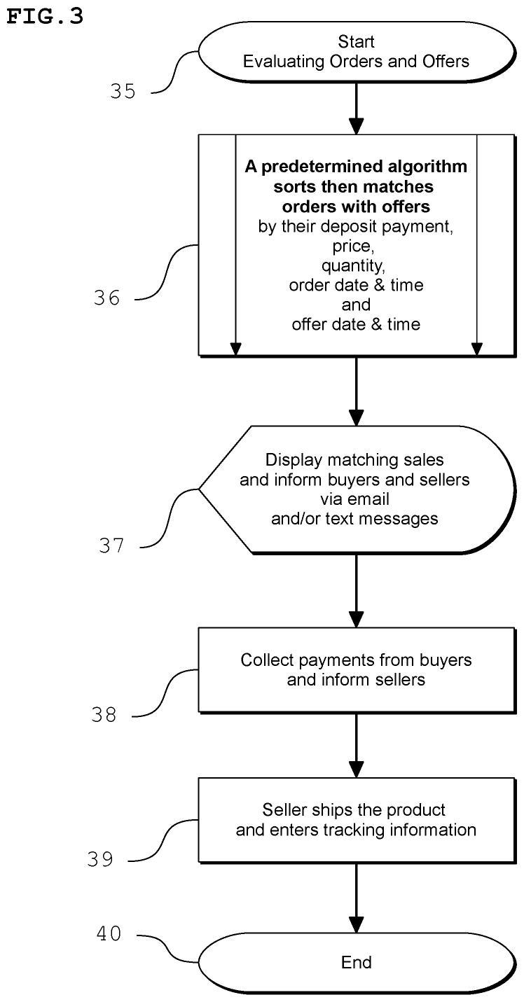

Referring to FIG. 3, there is depicted the flowchart showing the backend process to evaluate orders and offers means matching orders with offers to determine sales; then taking payments from buyers to finalize the auction process. Evaluation process starts 35 after all orders and offers collected 34 until the auction closing date. Using a predefined algorithm 36 orders and offers are sorted then compared against each other to find matching sales. The matching sales are displayed then emailed and/or texted to buyers and sellers 37. Payments are collected 38 from buyers, then sellers are informed. After sellers ship and enter the tracking information 39, the auction process ends 40.

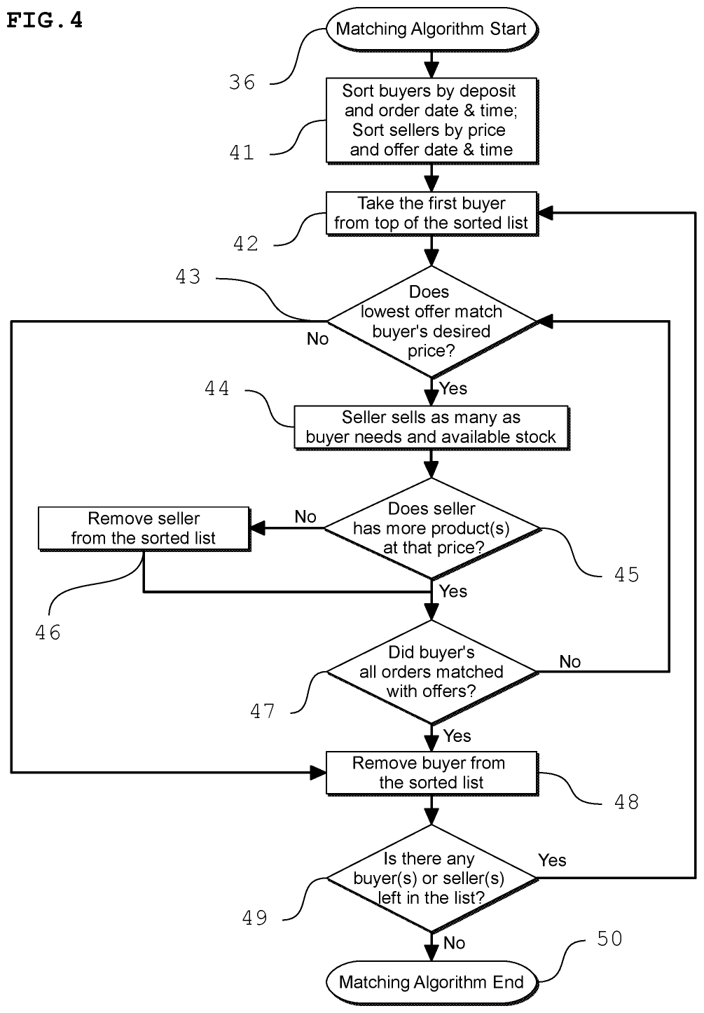

Referring to FIG. 4, there is depicted the flowchart explaining the backend algorithm 36 matching orders with offers to determine sales. Buyers are sorted 41 by their deposit payment by placing the buyers who paid deposit above the buyers who haven't paid deposit, then order entry date and time in ascending order; sellers are sorted 41 by their offer price in ascending order and by offer date and time in ascending order. The first buyer is taken from top of the sorted list 42 for evaluation. If there is no offer to match the buyer's desired price 43, the buyer is removed from the sorted list 48. If there is a matching offer 43, the seller sells as many as buyer requested or as many as stock on hand 44, whichever is lower. If the seller doesn't have more product to offer at that price 45, the seller is removed from the sorted list 46, otherwise seller remains in the list for possible sales to next buyer in the list. If buyer's all orders matched with an offer 47, the buyer is removed from the sorted list 48, otherwise the buyer remains in the list for possible purchase from the next seller in the sorted list. If there is more buyers and sellers left in the sorted lists 49, the algorithm repeats the process 42. The process ends 50 when there are no buyers or no sellers left in the sorted lists 49.

What I claim is:

1. A group reverse auction shopping method and a system comprising:
a database, hosted on a computer server connected to the internet, storing detailed information of application administrators, sellers, buyers, products, orders, offers, sales, payments, shipments and communication between buyers and sellers; and
a file system storing said database and the pictures of the said products; and
an online computer application comprising:
an interface to manage application settings, users and products;
an interface for sellers to register and get accredited in order to use the said application;
an interface for administrators and sellers to enter product information into said database and upload the pictures to said file system;
an interface for administrator to deactivate products and application users in case of an improper or illegal use;
an interface for buyers to register in order to use the said application;
an interface for buyers to search the product they would like to order;
an interface for registered buyers to enter their orders, comprising:
product name, brand, model, color;
desired purchase price, quantity;
shipping method; and
auction closing date;
an interface for registered buyers to enter their credit card information for payments;
an interface for buyers to make deposit payments;
an interface for sellers to search the orders to find products they can submit offers;
an interface for sellers to enter their offers, comprising:
price; and
quantity;
an interface to display orders and matching offers;
an interface to display sales after auction closing date;
an interface for buyers to make payments;
an interface for sellers to enter shipment information; and
a backed process comprising:
an algorithm to combine the buyer orders by a specific criteria to create individual group orders;
a process to close group orders at said auction closing date; and
an algorithm to match buyer orders to seller offers to determine sales within the said group order.

2. The group reverse auction shopping method and a system of claim 1, wherein the orders of a particular product with same brand, model, color, shipping method and auction closing date are combined into a single group order.

3. The group reverse auction shopping method and a system of claim 1, wherein sellers submit their offer price and quantity for the group order of claim 2 until the auction closing date.

4. The group reverse auction shopping method and a system of claim 1, wherein the online computer application allows new buyers and sellers to join to the group order of claim 2, allows sellers to offer the same price and allows all buyers and sellers to change their price and quantity until the auction closing date.

5. The group reverse auction shopping method and a system of claim 1, wherein the orders and offers matched within the group order of claim 2 to determine sales by an algorithm comprising:
sorting the buyers by their deposit payment by placing the buyers who paid deposit above the buyers who haven't paid deposit and by order entry date and time in ascending order;
sorting the sellers by their price in ascending order and by offer submission date and time in ascending order;
matching the first buyer with the first seller from the top of the sorted lists if the seller's offer price is equal or lower than buyer's desired purchase price;
keeping the first buyer in the sorted list to match with next seller if the first seller didn't have enough quantity on hand;
removing the first buyer from the sorted list if the buyer's all quantities were matched or none of the remaining offers match buyer's desired purchase price, consequently making the next buyer as the first buyer in the sorted list;
keeping the first seller in the sorted list if the seller's offered quantity is more than the first buyer's requested quantity;
removing the first seller from the list if all of the offered products were sold or none of the remaining buyers' desired purchase price match seller's offered price, consequently making the next seller as the first seller in the sorted list; and
repeating the steps for next buyer until all orders processed or no offers remained.

6. The group reverse auction shopping method and a system of claim 1, wherein the auction process is completed when buyers and sellers were informed about the sales, buyers submitted their payments and sellers entered their shipping tracking information.
